(19) United States
(12) Patent Application Publication
(10) Pub. No.: US 2017/0182841 A1
(43) Pub. Date: Jun. 29, 2017

(54) BICYCLE RIM STRUCTURE FOR EASIER INSTALLATION OF TAPE

(71) Applicant: Clever CHEN, WHITTIER, CA (US)

(72) Inventor: Clever CHEN, WHITTIER, CA (US)

(21) Appl. No.: 15/088,929

(22) Filed: Apr. 1, 2016

(30) Foreign Application Priority Data
Dec. 23, 2015 (TW) 104143325

(51) Int. Cl. B60B 21/12; B60C 29/02; B60B 21/06

(52) U.S. Cl. CPC B60B 21/12; B60B 21/062; B60C 29/02; B60B 1/003

(57) ABSTRACT

The present invention relates to a bicycle rim structure for easier installation of tape, which includes a rim body and a tape, wherein the tape is a strip wound around an outer side of the rim body, an engagement structure is provided to engage the two end taps overlapped each other, so that the installation of the tape become convenient and quick, and the tape may effectively protect an inner tube to avoid the inner tube being punctured and extend useful life of bicycles. At least a lightening hole is further set on the rim body, and at least a LED set in a corresponding position of the lightening hole on the tape to achieve a light warning effect. By the above composition, the purpose of easier installation of tape and enhancing efficiency in the use may be achieved for product promotion.

### BACKGROUND OF THE INVENTION

a) Field of the Invention

The invention relates to a bicycle rim structure for easier installation of tape and, more particularly, to a bicycle rim structure for bicycle field which could achieve the purpose of easier installation of tape and enhancing efficiency in the use, to thereby promote products.

b) Description of Prior Art

With the attention of environmental pollution, people are more aware of the importance of energy saving and carbon reduction. Bicycles and electric vehicles become popular for government and personal consideration. Bicycles and electric vehicles that relieve urban traffic pressure effectively and also reduce environmental pollution may gradually become a popular way to go green. Bicycles, electric vehicles and tricycles are very common in our country, and inner tubes are needed in these vehicles. If an inner tube directly touches an outer side of a rim during use, the inner tube may easily be punctured by a spoke mounting hole and a screw on the rim, so that the inner tube may leak and the vehicle could not work normally, thus it is inconvenient for users.

In order to solve this problem, a tape may be provided to set on the outer side of the rim body in industry, so that the spoke mounting hole and the screw on the rim may be separated from the inner tube to avoid being punctured. Usually, the tape is produced as a closed loop belt, and may be set on the outer side of the rim body during assembly. In the setting process, the valve through-hole on the tape should be aligned to the valve mounting hole on the rim body. If the position is not aligned, the user should move the tape to align the valve through-hole and the valve mounting hole, thus the process is very laborious and time-consuming, it is really inconvenient for users.

### SUMMARY OF THE INVENTION

In view of this, the invention discloses a bicycle rim structure for easier installation of tape, namely, the object of the invention is to a bicycle rim structure for convenient installation of tape, to thereby achieve the purpose of quick installation and easy operation, and also enhance efficiency in the use for promotion of products.

To achieve the object, a bicycle rim structure for easier installation of tape according to the present invention, which includes a rim body and a tape, wherein:

the rim body, a valve mounting hole and multiple spoke mounting holes are set on it;

the tape, which is a strip, and is wound around an outer side of the rim body, two end taps and two valve through-holes are respectively set on two ends of the tape, the valve through-holes are corresponded to the valve mounting hole, an engagement structure is provided to engage the two end taps overlapped each other as a ring.

The engagement structure, which is glue, an overlap adhesive, or Velcro set on each end tap for attaching together, the engagement structure is provided for the two end taps to overlap connected to each other, so that the tape is provided to be quickly set on the outer side of the rim body.

The tape is made of a flexible film material, the flexible film material is PVC material, PE material, PP material, PU material, nylon material or paper material.

The tape is a strip tape.

The tape is consisted of at least two segments, the segments are connected together end-to-end to form the tape, colors and materials of the segments may be chosen according to usage requirements.

The rim body, at least a lightening hole is set on it, the shape of the lightening hole is a square, a rectangular, a polygon, a circle or an ellipse .

The rim body, at least a lightening hole is set on it, at least a LED corresponded to the lightening hole is set on the tape.

The lightening hole, a protective housing is further engaged on it, the protective housing is a colored transparent housing or a translucent housing.

### BRIEF DESCRIPTION OF THE DRAWINGS

FIG. 1 is a three-dimensional diagram of the present invention;

FIG. 2 is a two-dimensional structure diagram of the present invention;

FIG. 3 is a segmental schematic diagram of A-A plane of FIG. 2 of the present invention;

FIG. 4 is a partial enlarged schematic diagram of B part in FIG. 3 of the present invention;

FIG. 5 is a partial schematic diagram of another embodiment of the lightening hole of the present invention;

FIG. 6 is a two-dimensional exploded diagram of the tape according to the present invention;

FIG. 7 is a partial segmental schematic diagram of connection of two ends and the engagement structure of the tape of the present invention; and

FIG. 8 is a two-dimensional exploded diagram of another embodiment of the tape according to the present invention.

### DETAILED DESCRIPTION OF THE INVENTION

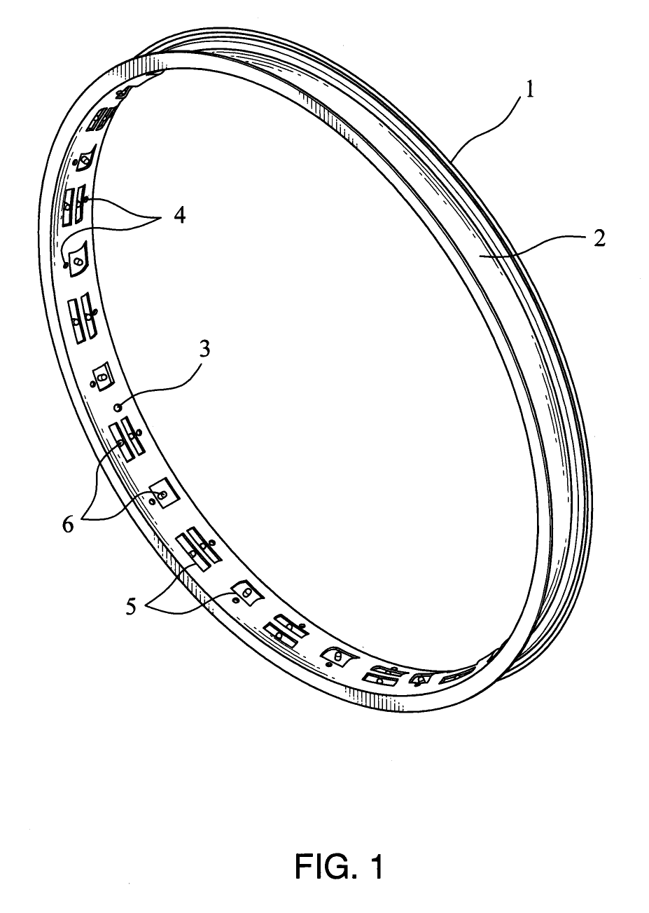

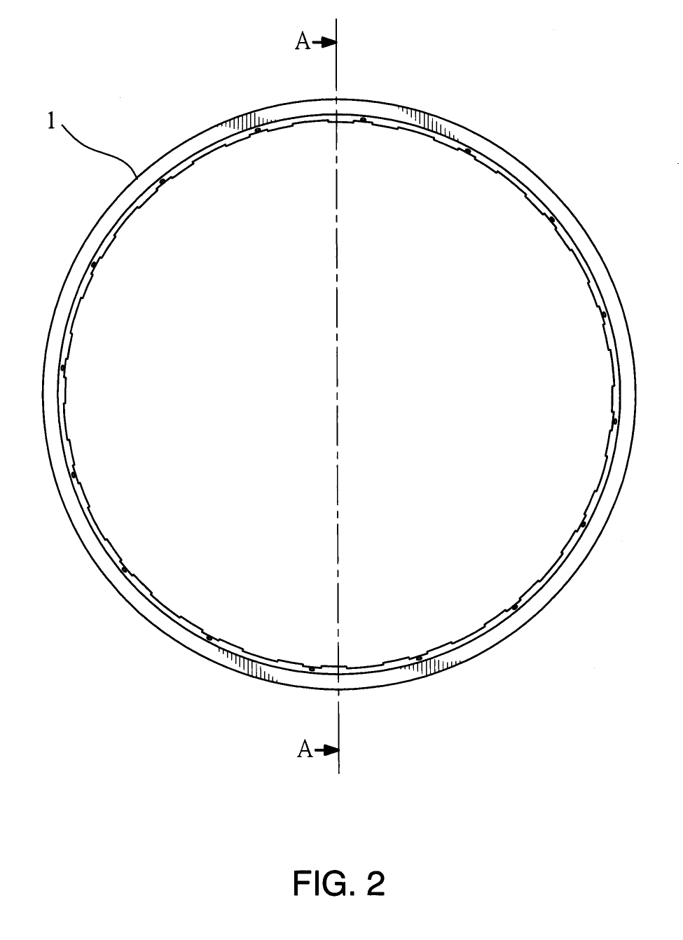

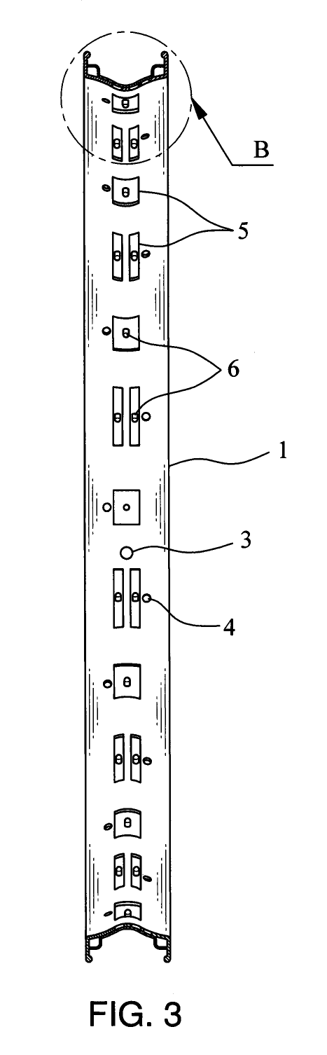

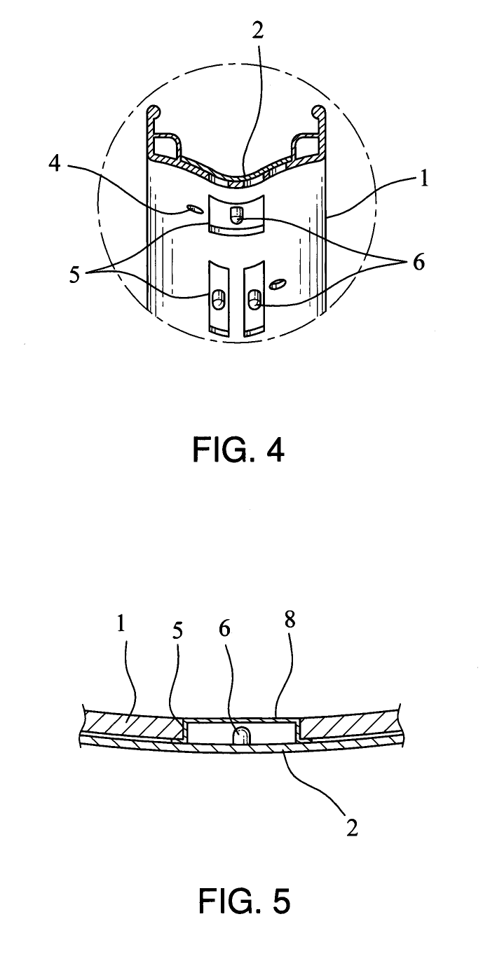

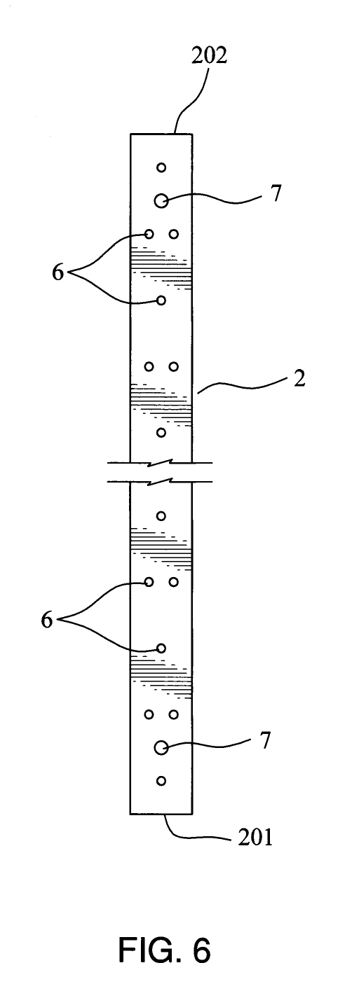

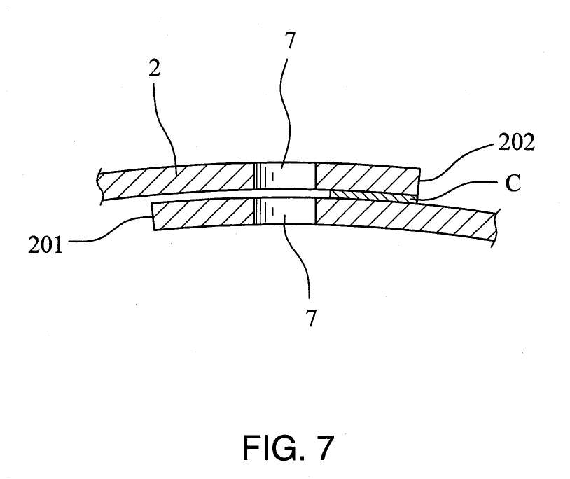

Please refer to FIG. 1-7, the bicycle rim structure for easier installation of tape according to the present invention, which includes a rim body 1 and a tape 2, wherein:

the rim body 1, which is a circular ring body, a valve mounting hole 3 and multiple spoke mounting holes 4 are set on it;

the tape 2, which is a strip, and is wound around an outer side of the rim body 1, two end taps 201, 202 and two valve through-holes 7 are respectively set on two ends of the tape 2, the valve through-holes 7 are corresponded to the valve mounting hole 3, an engagement structure C is provided to engage the two end taps 201, 202 overlapped each other as a ring.

The tape 2 is made of a flexible film material, the flexible film material is PVC material, PE material, PP material, PU material, nylon material or paper material.

The tape 2 is a strip tape.

The rim body 1, at least a lightening hole 5 is set on it, at least a LED 6 corresponded to the lightening hole 5 is set on the tape 2.

As shown in FIG. 5, in the present invention, in order to enhance the protection of the LED 6 and show more colors on the rim body 1, wherein a protective housing 8 is further engaged on the lightening hole 5 of the rim body 1, the protective housing 8 is a colored transparent housing or a translucent housing. By setting the protective housing 8 on the lightening hole 5, the LED 6 may be protected from exposing and being damaged easily. On the other hand, light color from the LED 6 may be various that may effectively achieve a light warning effect. Besides, the protective housing 8 has color, so overall color appearance of the rim body 1 may be enhanced in daytime that product value and warning effect may be improved effectively.

The lightening hole 5, its shape is a square, a rectangular, a polygon, a circle or an ellipse .

The engagement structure C, which is glue, an overlap adhesive, or Velcro set on each end tap 201, 202 for attaching together, the engagement structure is provided for the two end taps 201, 202 to overlap connected to each other, so that the tape 2 is provided to be quickly set on the outer side of the rim body 1.

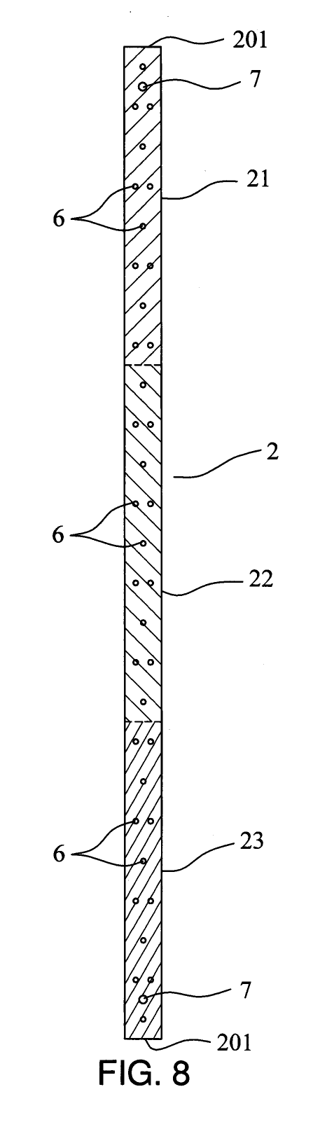

Please refer to FIG. 8, which is another embodiment of the tape 2 of present invention, wherein the tape 2 is consisted of at least two segments 21, 22, 23 connected together end-to-end to form the tape 2, two end taps 201, 202 and two valve through-holes 7 are set respectively on two ends of the tape 2, the valve through-holes 7 are corresponded to the valve mounting hole 3, two end taps 201, 202 are overlapped together, an engagement structure is provided to engage the two end taps as a ring. Colors and materials of the segments 21, 22, 23 may be chosen according to usage requirements, the colors may be the same and may also be different, the materials may be the same and may also be different, and the choice of these entirely depends on usage requirements. Therefore, color of the lightening hole 5 of the rim body 1 may show various color performance and light warning effect may be further improved with the LED 6.

By the above composition, when assembling, a user aligns the valve through-hole 7 on the end tap 201 of the tape 2 and the valve mounting hole 3 on the rim body 1 first, then pulls the end tap 202 around the outer side of the rim body 1 so as to overlap the two end taps 201, 202, aligns the valve mounting hole 3, and engages the two end taps 201, 202 by the engagement structure C, so that the tape 2 may be quickly set on the outer side of the rim body 1 and time for adjusting position may be saved.

The structure of the present invention is that the tape 2 may be installed by winding it around the outer side of the rim body 1; the conventional tape is a closed loop belt that should be forced to set on the outer side of the rim body, and it is inconvenient that if the valve through-hole and the valve mounting hole 3 on the rim body 1 are not aligned together. Accordingly, the installation of the tape 2 of the present invention is more convenient and progressive.

Above all, the bicycle rim structure of the present invention provides convenience of installing the tape, and the tape may effectively protect the inner tube from being punctured extend useful life of bicycles. The tape itself is a strip, end taps on its two ends may be quickly engaged by the engagement structure, so that installation of the tape become more convenient and quick. Also, the rim with lightening hole set on the rim body and the LED set correspondingly to the lightening hole on the tape may be more fashion that could meet needs of young people.

What is claimed is:

1. A bicycle rim structure for easier installation of tape, which includes a rim body and a tape, wherein:
the rim body, a valve mounting hole and multiple spoke mounting holes are set on it;
the tape, which is a strip, and is wound around an outer side of the rim body, two end taps and two valve through-holes are respectively set on two ends of the tape, the valve through-holes are corresponded to the valve mounting hole, an engagement structure is provided to engage the two end taps overlapped each other as a ring.

2. The bicycle rim structure for easier installation of tape as claimed in claim 1, wherein the engagement structure is glue, an overlap adhesive, or Velcro set on each end tap for attaching together, the engagement structure is provided for the two end taps to overlap connected to each other, so that the tape is provided to be quickly set on the outer side of the rim body.

3. The bicycle rim structure for easier installation of tape as claimed in claim 1, wherein the tape is made of a flexible film material.

4. The bicycle rim structure for easier installation of tape as claimed in claim 1, wherein the tape is made of a flexible film material, the flexible film material is PVC material, PE material, PP material, PU material, nylon material or paper material.

5. The bicycle rim structure for easier installation of tape as claimed in claim 1, wherein the tape is consisted of at least two segments, the segments are connected together end-to-end to form the tape.

6. The bicycle rim structure for easier installation of tape as claimed in claim 1, wherein the tape is consisted of at least two segments, the segments are connected together end-to-end to form the tape, colors and materials of the segments are chosen according to usage requirements.

7. The bicycle rim structure for easier installation of tape as claimed in claim 1, wherein at least a lightening hole is set on the rim body.

8. The bicycle rim structure for easier installation of tape as claimed in claim 1, wherein at least a lightening hole is set on the rim body, the shape of the lightening hole is a square, a rectangular, a polygon, a circle or an ellipse.

9. The bicycle rim structure for easier installation of tape as claimed in claim 1, wherein at least a lightening hole is set on the rim body, at least a LED corresponded to the lightening hole is set on the tape.

10. The bicycle rim structure for easier installation of tape as claimed in claim 1, wherein at least a lightening hole is set on the rim body, a protective housing is engaged on the lightening hole, the protective housing is a colored transparent housing or a translucent housing.
